(19) United States
(12) Patent Application Publication
(10) Pub. No.: US 2025/0078861 A1
(43) Pub. Date: Mar. 6, 2025

(54) ELECTRONIC DEVICE AND CONTROLLING METHOD OF ELECTRONIC DEVICE

(71) Applicant: Samsung Electronics Co., Ltd., Suwon-si (KR)

(72) Inventors: Oleksandra SOKOL, Kyiv (UA); Denys KARPENKO, Kyiv (UA); Sergii GRYSHCHENKO, Kyiv (UA); Andrii ASTRAKHANTSEV, Kyiv (KR)

(21) Appl. No.: 18/893,182

(22) Filed: Sep. 23, 2024

Related U.S. Application Data
(63) Continuation of application No. PCT/KR2024/013069, filed on Aug. 30, 2024.

(30) Foreign Application Priority Data
Sep. 1, 2023 (KR) 10-2023-0116485

(51) Int. Cl. G10L 25/69; G10L 25/30

(52) U.S. Cl. CPC G10L 25/69; G10L 25/30

(57) ABSTRACT

An electronic device and a controlling method of the electronic device are disclosed. The electronic device may include: a memory configured to store at least one instruction, and at least one processor, comprising processing circuitry, configured to execute the at least one instruction, and at least one processor, individually and/or collectively, is configured to: obtain an audio signal, input the audio signal into a preprocessing module and obtain feature information indicating features included in the audio signal, input the feature information into a vector obtaining module and obtain a feature vector corresponding to the audio signal based on the obtained feature information, and input the feature vector into a classification module and identify whether the audio signal is compressed two or more times. Here, each of the modules may include a neural network, and the feature information includes information on at least one from among a feature on a frequency domain of the audio signal, a feature on a time domain of the audio signal, and a feature on a frequency-time domain of the audio signal.

### CROSS-REFERENCE TO RELATED APPLICATIONS

This application is a continuation of International Application No. PCT/KR2024/013069 designating the United States, filed on Aug. 30, 2024, in the Korean Intellectual Property Receiving Office and claiming priority to Korean Patent Application No. 10-2023-0116485, filed on Sep. 1, 2023, in the Korean Intellectual Property Office, the disclosures of each of which are incorporated by reference herein in their entireties.

### BACKGROUND

### Field

The disclosure relates to an electronic device and a controlling method of the electronic device, and for example, to an electronic device capable of identifying whether an audio signal is multi-compressed by analyzing features of the audio signal and a controlling method thereof.

### Description of Related Art

Recently, financial fraud cases using communication mediums such as vishing and voice phishing are becoming a problem worldwide, and cases of damages caused by spam calls (e.g., robocalls), which generates a large amount of calls using automated voice messages or recorded calls, are ongoing.

To address problems as described above, various technical and legal measures have been taken, but as methods associated with vishing, voice phishing, and spam calls are also becoming more varied, cases of damages caused thereby are increasing.

As a representative related art, a spam blocking method is not effective with respect to newly generated spam phone numbers because it is based on a phone number blacklist which requires periodical database updates, and is limited in that the phone numbers need to be transmitted to an external database.

Accordingly, there is a growing need for technology which can detect and block illegal audios based on an audio signal itself within a device without needing maintenance management of the database.

### SUMMARY

Embodiments of the disclosure provide an electronic device capable of detecting whether an audio signal is multi-compressed by analyzing features of an audio signal and a controlling method thereof.

According to an example embodiment of the disclosure, an electronic device includes: a memory configured to store at least one instruction, and at least one processor, comprising processing circuitry, configured to execute the at least one instruction, wherein at least one processor, individually and/or collectively, is configured to: obtain an audio signal, input the audio signal in a preprocessing module comprising a neural network and obtain feature information indicating features included in the audio signal, input the feature information in a vector obtaining module comprising a neural network and obtain a feature vector corresponding to the audio signal based on the obtained feature information, and input the feature vector in a classification module comprising a neural network and identify whether the audio signal is compressed two or more times, wherein the feature information includes information on at least one from among a feature on a frequency domain of the audio signal, a feature on a time domain of the audio signal, and a feature on a frequency-time domain of the audio signal.

The preprocessing module may include at least one codec preprocessing module corresponding to at least one from among a plurality of codec types, wherein at least one processor, individually and/or collectively, may be configured to: identify a codec type of the audio signal, and input, based on the codec type of the audio signal being identified, the audio signal in a codec preprocessing module corresponding to the identified codec type from among the at least one codec preprocessing module, and obtain the feature information comprising features associated with the identified codec.

The preprocessing module may further include a default preprocessing module which does not correspond to the plurality of codec types, wherein at least one processor, individually and/or collectively, may be configured to input, based on the codec type of the audio signal not being identified, the audio signal in the default preprocessing module, and obtain the feature information.

The classification module may include at least one codec classification module corresponding respectively to at least one codec preprocessing module, and at least one processor, individually and/or collectively, may be configured to: input, based on the codec type of the audio signal being identified, the feature information obtained through the at least one codec preprocessing module in the at least one codec classification module corresponding to the at least one codec preprocessing module, and identify whether the audio signal is compressed two or more times.

The classification module may further include a default classification module corresponding to the default preprocessing module, and at least one processor, individually and/or collectively, may be configured to: input, based on the codec type of the audio signal not being identified, the feature information obtained through the default preprocessing module in the default classification module, and identify whether the audio signal is compressed two or more times.

At least one processor, individually and/or collectively, may be configured to identify the codec type of the audio signal based on metadata of the audio signal or information on a transmission channel of the audio signal.

The vector obtaining module may correspond to both the at least one codec preprocessing module and the default preprocessing module, and correspond to both the at least one codec classification module and the default classification module.

The classification module may be configured to output probability information indicating whether the audio signal is compressed two or more times, wherein each of the preprocessing module, the vector obtaining module, and the classification module may include a neural network, wherein the neural network may be trained according to a back-propagation of loss based on the probability information.

The electronic device may further include an outputter comprising output circuitry, and at least one processor, individually and/or collectively, may be configured to: control, based on the audio signal being identified as compressed two or more times, the outputter to not output the audio signal, and output a warning message for the audio signal.

According to an example embodiment of the disclosure, a method of operating an electronic device includes: obtaining an audio signal, obtaining, based on inputting the audio signal in a preprocessing module comprising a neural network, feature information indicating features included in the audio signal, obtaining, based on inputting the feature information in a vector obtaining module comprising a neural network, a feature vector corresponding to the audio signal based on the obtained feature information, and identifying, based on inputting the feature vector in a classification module comprising a neural network, whether the audio signal is compressed two or more times, and the feature information includes information on at least one from among a feature on a frequency domain of the audio signal, a feature on a time domain of the audio signal, and a feature on a frequency-time domain of the audio signal.

The preprocessing module may include at least one codec preprocessing module corresponding to at least one from among a plurality of codec types, and the obtaining feature information may include: identifying a codec type of the audio signal, and inputting, based on the codec type of the audio signal being identified, the audio signal in a codec preprocessing module corresponding to the identified codec type from among the at least one codec preprocessing module, and obtaining the feature information including features associated with the identified codec.

the preprocessing module may further include a default preprocessing module which does not correspond to the plurality of codec types, and the obtaining feature information may further include: inputting, based on the codec type of the audio signal not being identified, the audio signal in the default preprocessing module, and obtaining the feature information.

The classification module may include at least one codec classification module corresponding respectively to at least one codec preprocessing module, and the identifying whether the audio signal is compressed two or more times may include: inputting, based on the codec type of the audio signal being identified, the feature information obtained through the at least one codec preprocessing module in the at least one codec classification module corresponding to the at least one codec preprocessing module, and identifying whether the audio signal is compressed two or more times.

The classification module may further include a default classification module corresponding to the default preprocessing module, and the identifying whether the audio signal is compressed two or more times may further include: inputting, based on the codec type of the audio signal not being identified, the feature information obtained through the default preprocessing module in the default classification module, and identifying whether the audio signal is compressed two or more times.

The identifying a codec type of the audio signal may include identifying the codec type of the audio signal based on metadata of the audio signal or information on a transmission channel of the audio signal.

The vector obtaining module may correspond to both the at least one codec preprocessing module and the default preprocessing module, and correspond to both the at least one codec classification module and the default classification module.

The classification module may output probability information indicating whether the audio signal is compressed two or more times, and each of the preprocessing module, the vector obtaining module, and the classification module may include a neural network, and may be trained according to a back-propagation of loss based on the probability information.

According to an example embodiment of the disclosure a non-transitory computer-readable storage medium includes a program which, when executed by at least one processor of an electronic device, causes the electronic device to perform a controlling method, the controlling method including: obtaining an audio signal, obtaining, based on inputting the audio signal in a preprocessing module comprising a neural network, feature information indicating features included in the audio signal, obtaining, based on inputting the feature information in a vector obtaining module comprising a neural network, a feature vector corresponding to the audio signal based on the obtained feature information, and identifying, based on inputting the feature vector in a classification module comprising a neural network, whether the audio signal is compressed two or more times, and the feature information includes information on at least one from among a feature on a frequency domain of the audio signal, a feature on a time domain of the audio signal, and a feature on a frequency-time domain of the audio signal.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIG. 2 is a block diagram illustrating various modules according to various embodiments;

FIG. 3 is a block diagram illustrating in an example configuration of various modules according to various embodiments;

FIG. 4 is a block diagram illustrating an example configuration of an electronic device according various embodiments;

FIG. 5 is a flowchart illustrating an example method of controlling an electronic device according to various embodiments; and

FIG. 6 is a flowchart illustrating an example method of controlling an electronic device with respect to a subsequent process according to whether an audio signal is compressed two or more times according to various embodiments.

### DETAILED DESCRIPTION

Various modifications may be made to the various example embodiments of the disclosure, and there may be various types of embodiments. Accordingly, specific embodiments will be illustrated in drawings, and described in greater detail in the detailed description. However, it should be noted that the various embodiments are not intended to limit the scope of the disclosure to a specific embodiment, but the disclosure should be interpreted to include all modifications, equivalents and/or alternatives of the various embodiments. With respect to the description of the drawings, like reference numerals may be used to indicate like elements.

In the disclosure, in case it is determined that the detailed description of related known technologies or configurations may unnecessarily confuse the gist of the disclosure, the detailed description thereof may be omitted.

Further, the various embodiments below may be modified to various different forms, and it is to be understood that the scope of the technical spirit of the disclosure is not limited to the various embodiments below. Rather, the various example embodiments are provided so that the disclosure will convey the technical spirit of the disclosure to those skilled in the art.

Terms used in the disclosure have been used merely to describe various embodiments, and is not intended to limit the scope of protection. A singular expression includes a plural expression, unless otherwise specified.

In the disclosure, expressions such as “have,” “may have,” “include,” or “may include” are used to designate a presence of a corresponding features (e.g., elements such as numerical value, function, operation, or component), and not to preclude a presence or a possibility of additional features.

In the disclosure, expressions such as “A or B,” “at least one of A and/or B,” or “one or more of A and/or B” may include all possible combinations of the items listed together. For example, “A or B,” “at least one of A and B,” or “at least one of A or B” may refer to all cases including (1) at least one A, (2) at least one B, or (3) both of at least one A and at least one B.

Expressions such as “1st”, “2nd”, “first” or “second” used in the disclosure does not limit various elements regardless of order and/or importance, and may be used merely to distinguish one element from another element and does not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

On the other hand, when the certain element (e.g., the first element) is indicated as “directly coupled with/to” or “directly connected to” the another element (e.g., the second element), it may be understood as the other element (e.g., the third element) not being present between the certain element and the another element.

The expression “configured to . . . (or set up to)” used in the disclosure may be used interchangeably with, for example, “suitable for . . . ,” “having the capacity to . . . ,” “designed to . . . ,” “adapted to . . . ,” “made to . . . ,” or “capable of . . . ” based on circumstance. The term “configured to . . . (or set up to)” may not necessarily refer to being “specifically designed to” in terms of hardware.

Rather, in a certain circumstance, the expression “a device configured to . . . ” may refer, for example, to something that the device “may perform . . . ” together with another device or components. For example, the phrase “a processor configured to (or set up to) perform A, B, or C” may refer, for example, to a dedicated processor for performing a relevant operation (e.g., embedded processor), or a generic-purpose processor (e.g., a central processing unit (CPU) or an application processor) capable of performing the relevant operations by executing one or more software programs stored in a memory device.

The term ‘module’ or ‘part’ used in the various embodiments herein perform at least one function or operation, and may be implemented with a hardware or software, or implemented with a combination of hardware and software. In addition, a plurality of “modules” or a plurality of “parts,” except for a “module” or a “part” which needs to be implemented to a specific hardware, may be integrated in at least one module and implemented as at least one processor.

The various elements and areas of the drawings have been schematically illustrated. Accordingly, the technical spirit of the disclosure is not limited by relative sizes or distances illustrated in the accompanied drawings.

Embodiments of the disclosure will be described in greater detail below with reference to the accompanying drawings to aid in the understanding of the disclosure.

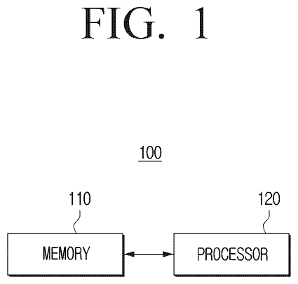

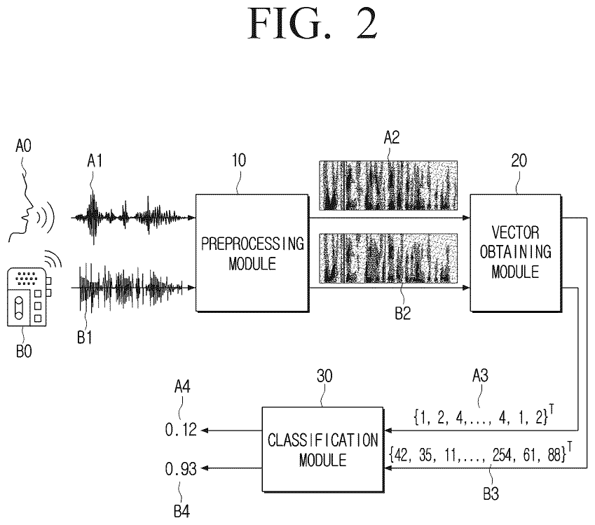

FIG. 1 is a block diagram illustrating an example configuration of an electronic device 100 according to various embodiments. FIG. 2 is a block diagram illustrating an example configuration of modules according to various embodiments. Various embodiments of the disclosure will be described in greater detail below with reference to both FIG. 1 and FIG. 2.

An ‘electronic device 100’ may refer to a device capable of identifying whether an audio signal is compressed two or more times. The electronic device 100 may not only be implemented as a device of various types such as a smart phone and a tablet personal computer (PC), but also implemented, for example, and without limitation, as a device such as a server and an edge computing device, or the like. In addition thereto, so long as it is a device implemented so as to identify whether the audio signal is compressed two or more times, it may correspond to the electronic device 100 according to the disclosure regardless of the type thereof.

As shown in FIG. 1, the electronic device 100 may include a memory 110 and a processor (e.g., including processing circuitry) 120. However, the embodiment is not limited thereto, and a new configuration may be added in addition to the configuration as shown in FIG. 1 or a portion of the configuration may be omitted in implementing the disclosure.

In the memory 110, at least one instruction associated with the electronic device 100 may be stored. Further, an operating system (O/S) for driving the electronic device 100 may be stored in the memory 110. In addition, various software programs or applications for the electronic device 10 to operate according to various embodiments of the disclosure may be stored in the memory 110. Further, the memory 110 may include a semiconductor memory such as a flash memory, a magnetic storage medium such as a hard disk, or the like.

For example, in the memory 110, various software modules for the electronic device 100 to operate may be stored according to the various embodiments of the disclosure, and the processor 120 may control an operation of the electronic device 100 by executing various software modules stored in the memory 110. The memory 110 may be accessed by the processor 120, and reading, writing, modifying, deleting, updating, and the like of data may be performed by the processor 120.

The term ‘memory 110’ in the disclosure may include the memory 110, a read only memory (ROM; not shown) within the processor 120, a random access memory (RAM; not shown), or a memory card (not shown) which is mounted to the electronic device 100 (e.g. a micro SD card, a memory stick).

According to various embodiments, the memory 110 may store various data or information such as, for example, and without limitation, audio signals, feature information, feature vectors, data on a plurality of modules, learning data for learning the plurality of modules, probability information, information on codec types, and the like. In addition thereto, various information may be stored in the memory 110, and the information stored in the memory 110 may be received from an external device or updated according the being input, for example, by a user.

The processor 120 may include various processing circuitry and control the overall operation of the electronic device 100. For example, the processor 120 may be coupled with a configuration of the electronic device 100 that includes the memory 110, and by executing the at least one instruction stored in the memory 110 as described above, control the overall operation of the electronic device 100.

The processor 120 may be implemented in various methods. For example, the processor 120 may be implemented as at least one from among an application specific integrated circuit (ASIC), an embedded processor, a microprocessor, a hardware control logic, a hardware finite state machine (FSM), and a digital signal processor (DSP). The term ‘processor 120’ in the disclosure may be used as a meaning that includes a central processing unit (CPU), a graphic processing unit (GPU), a micro processor unit (MPU), and the like. The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to various embodiments, the processor 120 may identify whether an audio signal is compressed two or more times by analyzing the features of the audio signal. For example, the processor 120 may identify whether the audio signal is compressed two or more times by analyzing the features of the audio signal using the plurality of modules. The plurality of modules may respectively include a neural network, and accordingly, the respective modules or the modules as a whole may be referred to as a neural network model.

As shown in FIG. 2, the plurality of modules may include a preprocessing module 10, a vector obtaining module 20, and a classification module 30, each of which may include a neural network. Below, it may be described assuming that all of the plurality of modules is included in the electronic device 100, and that it may be implemented as an on-device by the processor 120 included in the electronic device 100, but it may be implemented in a method in which at least one module from among the plurality of modules is included in an external device.

The processor 120 may obtain an audio signal. For example, the processor 120 may receive an audio signal from the external device through a communicator 130 included in the electronic device 100, and receive the audio signal through a microphone included in the electronic device 100. In addition thereto, there is no limitation in the method of obtaining the audio signal, and there is no special limitation to the type of the audio signal.

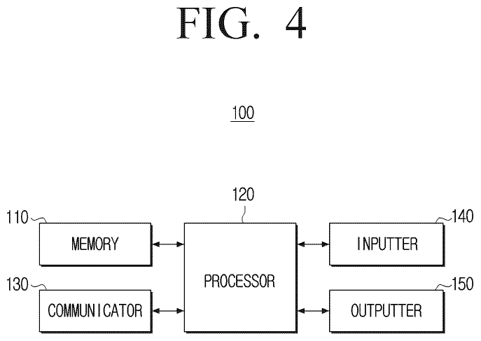

The example in FIG. 2 indicates both of when a first audio signal A1 is received from the external device through the communicator 130 of the electronic device 100 and when a second audio signal B1 is received from the external device through the communicator (e.g., including communication circuitry) 130 (refer to FIG. 4) of the electronic device 100. That is, the example of FIG. 2 is not indicating that the first audio signal A1 and the second audio signal B1 are input together in the preprocessing module 10, but that a process of processing the first audio signal A1 and the second audio signal B1 are indicated in parallel merely to describe a comparison.

In FIG. 2, the process of processing the first audio signal A1 may indicate, based on a user of the electronic device 100 carrying out a phone call with a counterpart A0 using the electronic device 100, an audio signal according to an utterance of the counterpart A0 being directly transmitted to the electronic device 100. In this case, the first audio signal A1 may be compressed one time when transmitting the signal.

The process of processing the second audio signal B1 may indicate, based on the user of the electronic device 100 carrying out a phone call with the counterpart A0 using the electronic device 100, the audio signal according to the utterance of the counterpart being transmitted to the electronic device 100 after being stored in an external device B0. In this case, because the second audio signal B1 is compressed not only when transmitting the signal, but also at recording by the external device B0, the second signal B1 may be ultimately compressed twice.

The audio signal compressed two or more times as the second audio signal B1 may indicate a high frequency being omitted in a multi-compression process or indicate an unnatural artifact and thereby, have a low quality. Accordingly, even if the audio signal is compressed using the same codec, a mutli-compression and a single-compression may be distinguished. For example, in the disclosure, accuracy, security, and efficiency of the multi-compression detection may be improved through a process which will be described in greater detail below.

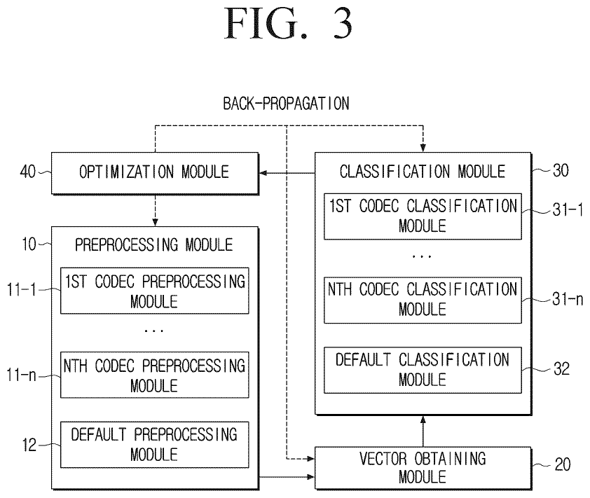

The processor 120 may obtain feature information indicating features included in an audio signal by inputting the audio signal to the preprocessing module 10. The ‘preprocessing module 10’ may refer to a module (e.g., including a neural network) which can perform preprocessing on the input audio signal and obtain (extract or generate) feature information of the audio signal. The preprocessing module 10 may include a neural network, and may be trained as described below with reference to FIG. 3. The preprocessing module 10 may be referred to as a ‘frontend’ because it may be a first (or early or initial) step in a process according to the disclosure, and may be referred to as a ‘low level feature extractor’ and the like.

In the description of the disclosure, ‘feature information’ may collectively refer to information on a feature obtainable by analyzing the audio signal, but may be used interchangeably a feature vector which will be described in greater detail below. For example, the feature information may refer to information on a low level feature obtainable by analyzing the audio signal itself whereas, the feature vector may be obtained by converting the feature information of a low level to a vector, and may refer, for example, to information on a high level feature which can be mapped in a vector space. In this aspect, the term feature information may be substituted with terms such as ‘low level feature information’ or ‘first level feature information’.

For example, the feature information may include information on at least one from among a feature on a frequency domain of the audio signal, a feature on a time domain of the audio signal, and a feature on a frequency-time domain of the audio signal.

For example, the feature on the frequency domain of the audio signal may include a feature on energies for each of the frequency domains of the audio signal, and the like. The feature on the time domain of the audio signal may include statistical features such as, for example, and without limitation, average, dispersion, skewness, kurtosis, and the like in the time domain of the audio signal. The feature on the frequency-time domain of the audio signal may be represented as a spectrogram which visually indicates a spectrum of a signal according to frequency and time, a Mel-Frequency Cepstral Coefficient (MFCC), and the like.

As an example, in FIG. 2, a first spectrogram A2 indicating feature information corresponding to the first audio signal A1 and a second spectrogram B2 indicating feature information corresponding to the second audio signal B1 are shown. However, there may be various feature information of the audio signal in addition to the above-described example, and for example, may be different according to a codec used in the compression of the audio signal which will be described below. In addition, the feature information of the audio signal may be extracted after performing various conversions such as Fourier Transform (FT) on the audio signal.

The processor 120 may input the feature information in the vector obtaining module 20, and obtain the feature vector corresponding to the audio signal based on the obtained feature information. The ‘vector obtaining module 20’ may refer to a module which can obtain (extract or generate) the feature vector corresponding to the audio signal by extracting the features of the audio signal. For example, when the feature information of the audio signal is input from the preprocessing module 10, the vector obtaining module 20 may convert the feature information to the feature vector by extracting the high level feature included in the feature information of the audio signal. The vector obtaining module 20 may be referred to as a ‘feature extractor’, a ‘high level feature extractor’, or the like.

The ‘feature vector’ may refer to a vector which indicates the features of the audio signal. As described above, the feature vector may be a result of quantifying the feature information of the audio signal and converting the same to a vector, and may be distinguished from the feature information in that it can indicate a higher level feature than the feature information. In this aspect, the term feature vector may be used interchangeably with terms such as ‘high level feature information’, ‘second level feature information’, or the like. If the feature information is converted to the feature vector, the audio signal may be easily classified through the neural network according to the distribution of the feature vector corresponding thereto.

As in the example of FIG. 2, when the first spectrogram A2 indicating the feature information corresponding to the first audio signal A1 is input, the vector obtaining module 20 may output a first feature vector A3 as described in FIG. 2. When the second spectrogram B2 indicating the feature information corresponding to the second audio signal B1 is input, the vector obtaining module 20 may output a second feature vector B3 as illustrated in FIG. 2.

The processor 120 may identify whether the audio signal is compressed two or more times by inputting the feature vector in the classification module 30. The ‘classification module 30’ may refer to a module which can identify whether the audio signal is compressed two or more times (e.g., whether multi-compression is carried out) based on the feature vector corresponding to the audio signal. The classification module 30 may be referred as a ‘classifier’ in brief.

For example, the classification module 30 may map the feature vector corresponding to the audio signal compressed one time and the feature vector corresponding to the audio signal compressed two or more times as different domains (classes or categories) from each other. When the feature vector is input from the vector obtaining module 20, the classification module 30 may output probability information (or probability value) indicating whether the audio signal is compressed two or more times according to the distribution of the feature vector.

In the example of FIG. 2, because the first feature vector A3 indicates the features of the first audio signal A1 compressed one time when transmitting the signal, it may indicate a different distribution with the second feature vector B3 which indicates the features of the second audio signal B1 compressed two times when recording and transmitting the signal.

For example, the classification module 30 may output probability information A4 that a probability of when the first audio signal A1 is compressed two or more times is 0.12, and output probability information B4 that a probability of when the second audio signal B1 is compressed two or more times is 0.93.

The processor 120 may identify whether the audio signal is multi-compressed based on the probability information obtained through the classification module 30. In the example of FIG. 2, if a threshold probability is 0.9, the processor 120 may identify that the first audio signal A1 has been compressed one time, and identify that the second audio signal B1 has been compressed two or more times.

Based on whether the audio signal is multi-compressed being identified, the processor 120 may determine a security of the audio signal based on whether the audio signal is multi-compressed. For example, if the audio signal includes illegal elements such as damage to security such as spam calls (e.g., robocalls) vishing, voice phishing, or the like, invasion of privacy, financial fraud, and the like, there is a high possibility of the audio signal being pre-recorded or modulated. Accordingly, if the audio signal is identified as compressed two or more times, the processor 120 may determine that the relevant audio signal is an audio signal that includes illegal elements as described above.

In addition, the processor 120 may determine the quality of the audio signal based on whether the audio signal is multi-compressed. For example, if a low quality audio signal is converted to a high quality audio signal, the audio signal may be multi-compressed in a process of encoding to the high quality audio signal. Accordingly, if the audio signal is identified as compressed two or more times, the processor 120 may determine that the relevant audio signal is actually low quality but has been converted (e.g., modulated) to have a high quality format.

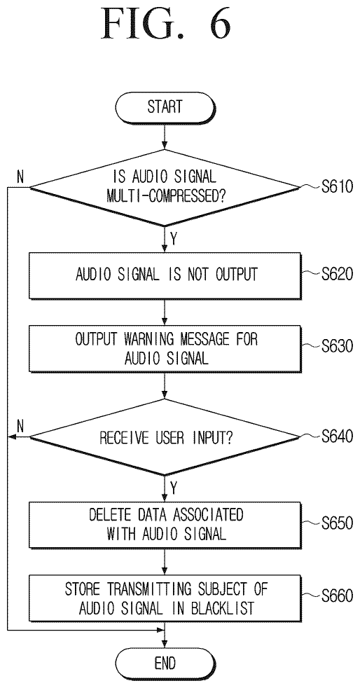

If the security of the audio signal or the quality of the audio signal has been determined as described above, the processor 120 may provide the user with information on the determined security of the audio signal or the determined quality of the audio signal. In addition to the providing of the information to the user, a subsequent process after the security of the audio signal or the quality of the audio signal is determined will be described below with reference to FIG. 4 and FIG. 6.

According to the above-described embodiments with reference to FIG. 1 and FIG. 2 above, the electronic device 100 may identify spam calls, vishing, voice phishing, whether the audio signal is a forgery or modulation, audio quality, and the like by analyzing the features of the audio signal using the plurality of modules which include the neural network and by accurately identifying whether the audio signal is multi-compressed.

For example, the electronic device 100 may protect the privacy of the user and identify whether the audio signal is multi-compressed without having to maintain and manage a database because whether the audio signal is multi-compressed is identified through a self-analysis within a device without having to share the audio signal with an external server.

FIG. 3 is a block diagram illustrating example configurations of various modules according to various embodiments.

As shown in FIG. 3, the plurality of modules according to the disclosure may not only include the preprocessing module 10, the vector obtaining module 20, and the classification module 30, but also an optimization module 40 for learning at least one from among the preprocessing module 10, the vector obtaining module 20, and the classification module 30. In addition, the preprocessing module 10 and the classification module 30 may respectively further include detailed modules as shown in FIG. 3. Each of these modules may include all or a portion of a neural network.

The preprocessing module 10 may include at least one codec preprocessing module 11 (e.g., including 11-1 to 11-n) and a default preprocessing module 12. Here, ‘codec’ may refer to an audio codec which is a software used in a compression of an audio signal, but the disclosure is not limited thereto. The codec may be used in generating a compressed audio signal by compressing an audio signal converted to a digital signal so as to include at least a portion of the information included in the audio signal.

For example, various codecs may be used in the compression of an audio signal, and each of the codecs may have various features. For example, the various audio codecs may have various different features such as, for example, and without limitation, an adaptive multi-rate (AMR) codec which can reduce data transmission bandwidth while maintaining call quality, an advanced audio coding (AAC) codec which is used in high quality audio compression, an opus codec which is used in high quality audio compression for internet calls or voice chatting, a vorbis codec which uses a loss compression method, and the like. Accordingly, when considering the features of each of the various audio codecs, the features of the audio signal may be more effectively extracted.

The ‘codec preprocessing module 11’ may refer to the preprocessing module 10 corresponding to one from among a plurality of codec types. The codec preprocessing module 11 may be the preprocessing module 10 specialized in a specific codec, and may be a module for extracting the feature information of the audio signal taking into consideration the features of the codec used in the compression of the audio signal. The codec preprocessing module 11 may be referred to in terms such as a ‘codec specific preprocessing module 10’.

There is no limitation to the number of the codec preprocessing modules 11, and a specific codec preprocessing module 11 may be added to the plurality of modules or updated by being removed from the plurality of modules.

For example, a 1st codec classification module 11-1 in FIG. 3 may be the codec preprocessing module 11 corresponding to the AMR codec, and an nth codec classification module 11-n may be the codec preprocessing module 11 corresponding to the AAC codec.

The ‘default preprocessing module 12’ may refer to the preprocessing module 10 that does not correspond to the plurality of codec types. The default preprocessing module 12 may obtain, based on the codec type of the audio signal not being identified, the feature information by extracting general features of the audio signal without taking into consideration the features of the codec.

According to various embodiments, the processor 120 may identify the codec type of the audio signal. For example, the processor 120 may identify the codec type of the audio signal based on metadata of the audio signal or information on a transmission channel of the audio signal. For example, if the transmission channel of the audio signal is a global system for mobile communications (GSM) channel which is one from among digital communication standards used in mobile phone communication, the processor 120 may identify the codec type of the audio signal as a GMS codec.

If the codec type of the audio signal is identified, the processor 120 may obtain feature information including the features associated with the identified codec by inputting the audio signal to the codec preprocessing module 11 corresponding to the identified codec type from among the at least one codec preprocessing module 11. If the codec type of the audio signal is not identified, the processor 120 may obtain the feature information by inputting the audio signal in the default preprocessing module 12.

The classification module 30 may include at least one codec classification module 31 (e.g., including 31-1 to 31-n) and a default classification module 32. The ‘codec classification module 31’ may refer to the classification module 30 corresponding to one from among the plurality of codec types, and accordingly, may correspond to at least one codec preprocessing module 11. The codec classification module 31 may be the classification module 30 specialized in a specific codec, and identify whether the audio signal is multi-compressed by taking into consideration the features of the codec used in the compression of the audio signal. The codec classification module 31 may be referred to in terms such as a ‘codec specific classification module 30’.

There is no limitation to the number of codec classification modules 31, and a specific codec classification module 31 may be added to the plurality of modules or updated by being removed from the plurality of modules.

For example, a 1st codec classification module 31-1 in FIG. 3 may be the codec classification module 31 corresponding to the AMR codec, and an nth codec classification module 31-n may be the codec classification module 31 corresponding to the AAC codec.

The ‘default classification module 32’ may refer to the classification module 30 that does not correspond to the plurality of codec types, and accordingly, may correspond to the default preprocessing module 12. The default preprocessing module 12 may identify, based on the codec type of the audio signal not being identified, whether the audio signal is multi-compressed without taking into consideration the features of the codec.

According to various embodiments, if the codec type of the audio signal is identified, the processor 120 may input the feature information obtained through the at least one codec preprocessing module 11 to the at least one codec classification module 31 which corresponds to the at least one codec preprocessing module 11, and identify whether the audio signal is compressed two or more times. If the codec type of the audio signal is not identified, the processor 120 may input the feature information obtained through the default preprocessing module 12 in the default classification module 32 and obtain the feature information.

If the preprocessing module 10 as described above and the detailed modules of the classification module 30, that is, if the codec specific modules are used, the features of the audio signal may be accurately extracted taking into consideration the codec type of the audio signal, and accordingly, accuracy of the multi-compression detection of the audio signal may be improved.

In addition, if the codec type of the audio signal cannot be identified, the default module may be used first in response, and because only detailed modules associated with a specific codec can be substituted/updated without change to other modules, there is an advantage of being able to easily respond to codecs of various new types.

As shown in FIG. 3, the vector obtaining module 20 may be implemented with one module. For example, according to various embodiments, the vector obtaining module 20 may correspond to both of the at least one codec preprocessing module 11 and the default preprocessing module 12, and correspond to both of the at least one codec classification module 31 and the default classification module 32.

For example, if the feature information is obtained from the audio signal using the at least one codec preprocessing module 11 and the default preprocessing module 12, the vector obtaining module 20 may obtain one feature vector by integrating the feature information obtained through the at least one codec preprocessing module 11 and the default preprocessing module 12, respectively, and mapping on an integrated vector space.

An embodiment of the plurality of detailed modules included in each of the preprocessing module 10 and the classification module 30 corresponding to one vector obtaining module 20 has been described, but the above is merely an example. Various detailed modules such as the vector obtaining module 20 or a detailed module specialized in a specific codec may be included according to an embodiment.

However, if outputs of the plurality of detailed modules included in the preprocessing module 10 are processed in the one vector obtaining module 20 as described above, there may be an advantage of a size of an entire system being reduced compared to when using separate modules for each of the codecs.

The optimization module 40 may refer to a module which can optimize the plurality of modules according to the disclosure. For example, the optimization module 40 may train the preprocessing module 10, the vector obtaining module 20, and the classification module 30 by applying various learning algorithms to the neural networks included in each of the preprocessing module 10, the vector obtaining module 20, and the classification module 30.

According to various embodiments, the training of the preprocessing module 10, the vector obtaining module 20, and the classification module 30 may be trained according to a back-propagation of loss which is based on the probability information obtained through the classification module 30.

A learning data set for the training of the preprocessing module 10, the vector obtaining module 20, and the classification module 30 may be obtained based on a single-compression audio dataset generated by compressing a raw audio dataset one time and a multi-compression audio dataset generated by compressing the raw audio dataset two or more times.

For example, the single-compression audio dataset may be dataset obtained by performing a voice call encoding on the raw audio dataset, and the multi-compression audio dataset may be dataset obtained by performing the voice call encoding after performing lossy encoding on the raw audio dataset. For example, various codecs may be used in the voice call encoding on the raw audio dataset, and dataset for each of the various codecs may be used in the training of the at least one codec preprocessing module 11 and the at least one codec classification module 31.

If learning dataset is obtained, the processor 120 may train the preprocessing module 10, the vector obtaining module 20, and the classification module 30 to classify the single-compression audio dataset as a negative class (e.g., a class indicating that it is an audio signal which is not multi-compressed), and to classify the multi-compression audio dataset as a positive class (e.g., a class indicating that it is an audio signal which is multi-compressed).

For example, if probability information indicating whether the audio signal is multi-compressed is output through the classification module 30 during the training process, the processor 120 may obtain loss (or a loss value) based on a difference between the probability information output through the classification module 30 and probability information of a label, and train the preprocessing module 10, the vector obtaining module 20, and the classification module 30 by back-propagating the obtained loss to the preprocessing module 10, the vector obtaining module 20, and the classification module 30.

The loss used in the training according to the disclosure may be obtained using various loss functions such as, for example, and without limitation, a mean squared error (MSE), a cross-entropy loss, a focal loss, an L1 loss, and the like, there is no special limitation to a type of learning and a type of loss used in the learning.

FIG. 4 is a block diagram illustrating an example configuration of the electronic device 100 according to various embodiments.

As shown in FIG. 4, the electronic device 100 may include not only the memory 110 and the processor (e.g., including processing circuitry) 120, but also the communicator (e.g., including communication circuitry) 130, an inputter (e.g., including input circuitry) 140, and an outputter (e.g., including output circuitry) 150. However, the configurations as shown in FIG. 1 and FIG. 4 are merely examples, and new configurations may be added in addition to the configurations as shown in FIG. 1 and FIG. 4 or a portion of the configurations may be omitted in implementing the disclosure.

The communicator 130 may include circuitry, and perform communication with an external device. For example, the processor 120 may receive various data or information from the external device connected through the communicator 130, and transmit various data or information to the external device.

The communicator 130 may include at least one from among a Wi-Fi module, a Bluetooth module, a wireless communication module, an NFC module, and an ultra-wide band (UWB) module. Specifically, the Wi-Fi module and the Bluetooth module may perform communication in a Wi-Fi method and a Bluetooth method, respectively. When using the Wi-Fi module or the Bluetooth module, various connection information such as a service set identifier (SSID) may be first transmitted and received, and various information may be transmitted and received after communicatively connecting using the same.

In addition, the wireless communication module may perform communication according to various communication standards such as, for example, and without limitation, IEEE, Zigbee, 3rd Generation (3G), 3rd Generation Partnership Project (3GPP), Long Term Evolution (LTE), 5th Generation (5G), and the like. Further, the NFC module may perform communication in a near field communication (NFC) method which uses a 13.56 MHz bandwidth from among various RF-ID frequency bandwidths such as, for example, and without limitation, 135kHz, 13.56 MHz, 433 MHZ, 860˜960 MHz, 2.45 GHz, and the like. In addition, the UWB module may accurately measure a time of arrival (ToA) which is time by which a pulse reaches a target, and an angle of arrival which is a pulse angle of arrival from a transmitting device through communication between UWB antennas, and accordingly, accurate recognition of distance and position within indoors may be possible in an error margin of within several centimeters (cm).

According to various embodiments, the processor 120 may control the communicator 130 to receive the audio signal from the external device through the communicator 130, and transmit the audio signal to the external device. For example, if a phone call is performed between the electronic device 100 and the external device, the processor 120 may allocate a frequency band for the call between the electronic device 100 and the external device through the communicator 130, and establish a communication channel. When the communication channel is established, the processor 120 may receive the audio signal from the external device through the established communication channel, and control the communicator 130 to transmit the audio signal to the external device through the established communication channel.

For example, various technologies such as, for example, and without limitation, a Voice over Internet Protocol (VoIP) which is technology of transmitting voice calls using internet protocols, a Global System for Mobile Communications (GSM) which is an international standard communication technology for mobile phone communication, a Voice over LTE which is a long-term evolution (LTE) network based voice call transmission technology, or the like may be used in phone calls between the electronic device 100 and the external device.

The processor 120 may have, by controlling the communicator 130 to transmit the audio signal received from the external device to an external output device (e.g., a Bluetooth speaker, wireless earphones, etc.), sound corresponding to the audio signal to be output through the external output device.

The processor 120 may have, based on the audio signal being identified as compressed two or more times, a transmitting subject of the audio signal to be registered in a spam list which is managed by an external server by transmitting information on the transmitting subject of the audio signal to the external server.

In addition, the processor 120 may transmit and receive various data or information such as, for example, and without limitation, data on the audio signal, the feature information, the feature vector, and the plurality of modules, learning data for training the plurality of modules, information on the probability information and the codec type, and the like through the communicator 130.

The inputter 140 may include circuitry, and the processor 120 may receive a user command for controlling an operation of the electronic device 100 through the inputter 140. For example, the inputter 140 may be formed of configurations such as a microphone, a camera (not shown), and a remote controller signal receiver (not shown). Further, the inputter 140 may be implemented in a form included in a display as a touch screen. For example, the microphone may receive a voice signal, and convert to the received voice signal into an electric signal.

According to various embodiments, the processor 120 may receive a user input for identifying whether the audio signal is mutli-compressed through the inputter 140. In addition, the processor 120 may delete, based on the multi-compression of the audio signal being identified through the inputter 140, data associated with the audio signal, or receive a user input for storing the transmitting subject of the audio signal in the blacklist.

The outputter 150 may include circuitry, and the processor 120 may output various functions performable by the electronic device 100 through the outputter 150. Further, the outputter 150 may, for example, include at least one from among a display, a speaker, and an indicator.

The display may output image data by the control of the processor 120. For example, the display may output an image pre-stored in the memory 110 by the control of the processor 120. For example, the display according to an embodiment of the disclosure may display a user interface stored in the memory 110. The display may be implemented as a liquid crystal display (LCD) panel, organic light emitting diodes (OLED), and the like, and the display may be implemented as a flexible display, a transparent display, and the like according to circumstance. However, the display according to the disclosure is not limited to a specific type.

The speaker may output audio data by the control of the processor 120, and the indicator may be turned-on by the control of the processor 120.

According to various embodiments, the processor 120 may control the speaker to output audio signals, and control the display to output information associated with the audio signal or texts corresponding to the audio signal. The texts corresponding to the audio signal may be obtained using a voice recognition model (an automatic speech recognition model (ASR) model).

According to various embodiments, if the audio signal identified as compressed two or more times, the processor 120 may control the outputter 150 to not output the audio signal, and output a warning message for the audio signal. The warning message may be output in a voice through the speaker, output in text through the display, or output as a point of the indicator.

According to various embodiments, if the audio signal identified as compressed two or more times, the processor 120 may control the outputter 150 to delete data associated with the audio signal, or output a guide message for requesting user selection for a subsequent measure such as storing the transmitting subject of the audio signal in the blacklist.

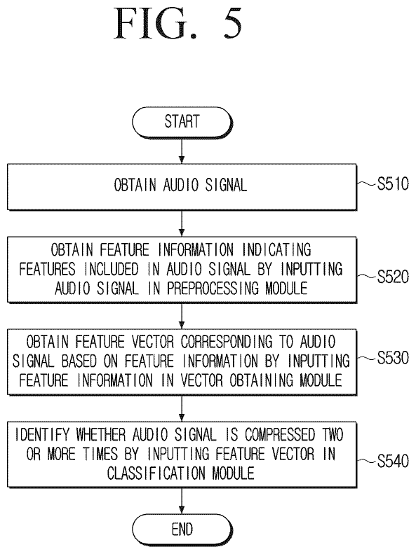

FIG. 5 is a flowchart illustrating an example method of controlling the electronic device 100 according to various embodiments.

The electronic device 100 may obtain an audio signal (S510). For example, the electronic device 100 may receive the audio signal from the external device through the communicator 130 included in the electronic device 100, and receive the audio signal through the microphone included in the electronic device 100.

When the audio signal is obtained, the electronic device 100 may input the audio signal in the preprocessing module 10, and obtain feature information indicating the features included in the audio signal (S520). The feature information may include information on at least one from among the feature on the frequency domain of the audio signal, the feature on the time domain of the audio signal, and the feature on the frequency-time domain of the audio signal.

When the feature information is obtained, the electronic device 100 may input the feature information in the vector obtaining module 20, and obtain the feature vector corresponding to the audio signal based on the feature information (S530). For example, when the feature information of the audio signal is obtained, the electronic device 100 may convert the feature information to the feature vector by extracting the high level feature included in the feature information of the audio signal.

In the disclosure, while the feature information may refer, for example, to information on the low level feature which can be obtained by analyzing the audio signal itself, the feature vector may be obtained by converting the low level feature information to the vector, and may refer, for example, to information on the high level feature which can be mapped in the vector space. The feature vector may be a result of having converted to the vector by quantifying the feature information of the audio signal, and may be differentiated from the feature information in that it can indicate a higher level feature than the feature information.

When the feature vector is obtained, the electronic device 100 may identify whether the audio signal has been compressed two or more times by inputting the feature vector in the classification module (S540). For example, the electronic device 100 may identify whether the audio signal is multi-compressed based on the probability information obtained through the classification module 30.

Based on whether the audio signal is multi-compressed being identified, the electronic device 100 may determine the security of the audio signal based on whether the audio signal is multi-compressed. For example, if the audio signal is identified as compressed two or more times, the processor 120 may determine that the relevant audio signal is the audio signal which includes illegal elements as described above. In addition, the electronic device 100 may determine the quality of the audio signal based on whether the audio signal is multi-compressed.

If the security of the audio signal or the quality of the audio signal is determined, the electronic device 10 may provide the user with information on the determined security of the audio signal or the determined quality of the audio signal.

FIG. 6 is a flowchart illustrating an example method with respect to a subsequent process whether an audio signal is compressed two or more times according to various embodiments.

In FIG. 6, an operation after having identified whether the audio signal is compressed two or more times due to step S540 in FIG. 5 being performed will be described.

As shown in FIG. 6, the electronic device 100 may identify whether the audio signal has been multi-compressed (S610). If the audio signal is identified as not having been multi-compressed (S610-N), the electronic device 100 may not perform a subsequent operation. For example, if the user of the electronic device 100 carries out a phone call with a user of the external device, the electronic device 100 may output through the speaker by continuously receiving the audio signal from the external device or transmit to the external output device (e.g., Bluetooth speaker, wireless earphones, etc.)

Based on the audio signal being identified as having been multi-compressed (S610-Y), the electronic device 100 may not output the audio signal (S620). For example, if the user of the electronic device 100 carries out a phone call with the user of the external device, the electronic device 100 may stop receiving the audio signal from the external device, or may not output through the speaker even if the audio signal is received from the external device and not transmit to the external output device.

Based on the audio signal being identified as having been multi-compressed (S610-Y), the electronic device 100 may output a warning message for the audio signal (S630). For example, the electronic device 100 may output a guide message cautioning that the audio signal may be a spam call, vishing, or voice phishing through the speaker. The guide message may be output in voice through the speaker, or output in text through the display.

In FIG. 6, based on the audio signal being identified as having been multi-compressed, the step of not outputting the audio signal (S620) and the step of outputting a warning message for the audio signal (S630) being both performed sequentially has been shown, but the disclosure is not limited thereto. For example, based on the audio signal being identified as having been multi-compressed, one step from among the step of not outputting the audio signal (S620) and the step of outputting a warning message for the audio signal (S630) may not be performed, and the step of outputting a warning message for the audio signal (S630) may be performed prior to the step of not outputting the audio signal (S620).

The electronic device 100 may receive the user input (S640). If the user input is not received (S640-N), the electronic device 100 may not perform the subsequent operation. If the user input is received (S640-Y), the electronic device 100 may delete data associated with the audio signal (S650), and store the transmitting subject of the audio signal in the blacklist (S660). For example, if the audio signal received while the user of the electronic device 100 performs a phone call with the user of the external device is identified as having been multi-compressed, the electronic device 100 may delete the audio signal received while performing the phone call and data associated therewith, and store a phone number of the user of the external device in the blacklist.

When the transmitting subject of the audio signal is stored in the blacklist, the electronic device 100 may store the phone number of the user of the external device in the blacklist and then, block phone calls called from that number.

The user input may not only be received after having identified whether the audio signal is multi-compressed as shown in FIG. 6, but also be received in advance in a user setting process on which operation is to be performed if the multi-compression of the audio signal is identified.

For example, if the multi-compression of the audio signal is identified, the step of not outputting the audio signal (S620) and the step of outputting a warning message for the audio signal (S630) may be automatically performed without the user input. In addition, if the user setting is carried out in advance according to the user input, not only the step of not outputting the audio signal (S620) and the step of outputting a warning message for the audio signal (S630) but also the step of deleting data associated with the audio signal (S650) and the step of storing the transmitting subject of the audio signal in the blacklist (S660) may be automatically performed.

The step of deleting data associated with the audio signal (S650) and the step of storing the transmitting subject of the audio signal in the blacklist (S660) are not necessarily both performed sequentially.

A controlling method of the electronic device 100 according to the above-described embodiment may be implemented with a program and provided to the electronic device 100. For example, a program which includes the controlling method of the electronic device 100 may be provided stored in a non-transitory computer readable medium.

For example, in terms of a non-transitory computer-readable storage medium which includes a program that executes the controlling method of the electronic device 100, the controlling method of the electronic device 100 may include obtaining the audio signal, obtaining feature information indicating features included in the audio signal by inputting the audio signal in the preprocessing module 10, obtaining the feature vector corresponding to the audio signal based on the obtained feature information by inputting the feature information in the vector obtaining module 20, and identifying whether the audio signal has been compressed two or more times by inputting the feature vector in the classification module 30. The feature information may include information on at least one from among the feature on the frequency domain of the audio signal, the feature on the time domain of the audio signal, and the feature on the frequency-time domain of the audio signal.

In the above, the controlling method of the electronic device 100, and the computer-readable storage medium including the program that executes the controlling method of the electronic device 100 have been briefly described, but this is merely to omit redundant descriptions, and various embodiments with respect to the electronic device 100 may be applied to the controlling method of the electronic device 100 and even to the computer-readable storage medium including the program that executes the controlling method of the electronic device 100.

According to the various embodiments of the disclosure as described above, the electronic device 100 may identify spam calls, vishing, voice phishing, whether the audio signal is a forgery or modulation, audio quality, and the like by analyzing the features of the audio signal using the plurality of modules which include the neural network and by accurately identifying whether the audio signal is multi-compressed.

For example, the electronic device 100 may protect the privacy of the user and identify whether the audio signal is multi-compressed without having to maintain and manage a database because whether the audio signal is multi-compressed is identified through the self-analysis within the device without having to share the audio signal with the external server.

In addition, if the preprocessing module 10 and the detailed modules of the classification module 30, that is, if the codec specific modules are used, the features of the audio signal may be accurately extracted taking into consideration the codec type of the audio signal, and accordingly, accuracy of the multi-compression detection of the audio signal may be improved.

If the codec type of the audio signal cannot be identified, the default module may be used first in response, and because only detailed modules associated with a specific codec can be substituted/updated without change to other modules, there is an advantage of being able to easily respond to codecs of various new types.

In addition, if outputs of the plurality of detailed modules included in the preprocessing module 10 are processed in the one vector obtaining module 20, there may be an advantage of the size of the entire system being reduced compared to when using separate modules for each of the codecs.

A function associated with an artificial intelligence according to the disclosure may be operated through the processor 120 and the memory 110 of the electronic device 100.

The processor 120 may be formed of the one or plurality of processors 120. At this time, the one or plurality of processors 120 may include at least one from among the CPU, the GPU, and a neural processing unit (NPU), but is not limited to the example of the above-described processor 120.

The CPU may be a generic-purpose processor 120 which can perform not only general operations but also artificial intelligence operations, and may effectively execute a complex program through a multi-layer cache structure. The CPU may be advantageous is a serial processing method which allows for an organic connection between a previous calculation result and a following calculation result through a consecutive calculation. The generic-purpose processor 120 is not limited to the above-described example except for when specified as the above-described CPU.

The GPU may be a processor 120 for mass operations such as a floating-point operation used in graphic operations, and may perform large-scale operations in parallel by integrating a large number of cores. For example, the GPU may be advantageous in a parallel processing method such as a convolution operation compared to the CPU. In addition, the GPU may be used as a co-processor 120 for supplementing a function of the CPU. The processor 120 for mass operations is not limited to the above-described example except for when specified as the above-described GPU.

The NPU may be a processor 120 specialized in artificial intelligence operations which uses an artificial neural network, and may implement each layer which forms the artificial neural network as hardware (e.g., silicon). At this time, because the NPU is designed specifically according to the requirements of a company, it may have a lower degree of freedom compared to the CPU or the GPU, but may effectively process an artificial intelligence operation required by the company. As the processor 120 specialized in artificial intelligence operations, the NPU may be implemented in various forms such as, for example, and without limitation, a tensor processing unit (TPU), an intelligence processing unit (IPU), a vision processing unit (VPU), and the like. The artificial intelligence processor 120 is not limited to the above-described example except for when specified as the above-described NPU.

In addition, the one or plurality of processors 120 may be implemented as a system on chip (SoC). The SoC may further include the memory 110 in addition to the one or plurality of processors 120, and a network interface such as a Bus for data communication between the processor 120 and the memory 110.

If the plurality of processors 120 is included in the system on chip (SoC) included in the electronic device 100, the electronic device 100 may perform operations (e.g., operations associated with learning or inference of an artificial intelligence model) associated with artificial intelligence using a portion of the processors 120 from among the plurality of processors 120. For example, the electronic device 100 may perform operations associated with artificial intelligence using at least one from among the GPU, the NPU, the VPU, the TPU, and the hardware accelerator which are specialized in artificial intelligence operations such as the convolution operation and a matrix multiplication operation from among the plurality of processors 120. However, the above is merely an example embodiment, and operations associated with artificial intelligence may be processed using the generic-purpose processor 120 such as the CPU.

In addition, the electronic device 100 may perform an operation with respect to a function associated with artificial intelligence using multi-cores (e.g., a dual core, a quad core, etc.) included in one processor 120. Specifically, the electronic device 100 may perform artificial intelligence operations such as, for example, and without limitation, convolution operations, matrix multiplication operations, and the like in parallel using the multi-cores included in the processor 120.

The one or plurality of processors 120 may perform control to process input data according to a pre-defined operation rule or an artificial intelligence model stored in the memory 110. The pre-defined operation rule or the artificial intelligence model may be characterized by being created through learning.

Being created through learning may refer to the pre-defined operation rule or the artificial intelligence model of a desired characteristic being formed by applying a learning algorithm to a plurality of learning data. The learning may be carried out in the machine itself in which the artificial intelligence according to the disclosure is performed, or carried out through a separate server/system.

The artificial intelligence model may be formed with a plurality of neural network layers. The at least one layer may have at least one weight value (weight values), and perform an operation of a layer through an operation result of a previous layer and at least one defined operation. Examples of the neural network may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep-Q Networks, and a Transformer, and the neural network of the disclosure is not limited to the above-described example, unless otherwise specified.

The learning algorithm may include a method for training a predetermined target machine (e.g., robot) to make decisions or predictions on its own using the plurality of learning data. Examples of the learning algorithm may include a supervised learning, an unsupervised learning, a semi-supervised learning, or a reinforcement learning, and the learning algorithm of the disclosure is not limited to the above-described example unless otherwise specified.

A machine-readable storage medium may be provided in the form of a non-transitory storage medium. Herein, the ‘non-transitory storage medium’ is a tangible device, and may not include a signal (e.g., electromagnetic waves), and the term does not differentiate data being semi-permanently stored or being temporarily stored in the storage medium. In an example, the ‘non-transitory storage medium’ may include a buffer in which data is temporarily stored.

According to an embodiment, a method according to the various embodiments of the disclosure described herein may be provided in a computer program product. The computer program product may be exchanged between a seller and a purchaser as a commodity. The computer program product may be distributed in a form of the machine-readable storage medium (e.g., a compact disc read only memory (CD-ROM)), or distributed online (e.g., downloaded or uploaded) through an application store (e.g., PLAYSTORE™) or directly between two user devices (e.g., smartphones). In the case of online distribution, at least a portion of the computer program product (e.g., downloadable app) may be stored at least temporarily in the storage medium such as a server of a manufacturer, a server of an application store, or a memory of a relay server, or temporarily generated.

Each of the elements (e.g., a module or a program) according to the various embodiments of the disclosure as described above may be formed of a single entity or a plurality of entities, and some sub-elements of the above-mentioned sub-elements may be omitted or other sub-elements may be further included in the various embodiments. Alternatively or additionally, some elements (e.g., modules or programs) may be integrated into one entity to perform the same or similar functions performed by the respective corresponding elements prior to integration.

Operations performed by a module, a program, or other element, in accordance with the various embodiments, may be executed sequentially, in parallel, repetitively, or in a heuristically manner, or at least some operations may be performed in a different order, omitted, or a different operation may be added.

The term “part” or “module” used in the disclosure may include a unit formed of a hardware, software, or firmware, or any combination thereof, and may be used interchangeably with terms such as, for example, and without limitation, logic, logic blocks, components, circuits, or the like. “Part” or “module” may be a component integrally formed or a minimum unit or a part of the component performing one or more functions. For example, a module may be formed as an application-specific integrated circuit (ASIC).

The various embodiments of the disclosure may be implemented with software including instructions stored in a machine-readable storage media (e.g., computer). The machine may call the stored instruction from the storage medium, and as a device operable according to the called instruction, may include an electronic device (e.g., electronic device 100) according to various embodiments described above.

Based on the instruction being executed by the processor, the processor may directly or using other elements under the control of the processor perform a function corresponding to the instruction. The instruction may include a code generated by a compiler or executed by an interpreter.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a memory configured to store at least one instruction; and
at least on processor, comprising processing circuitry, configured to execute the at least one instruction,
wherein at least one processor, individually and/or collectively, is configured to
obtain an audio signal,
input the audio signal into a preprocessing module, comprising a neural network, and obtain feature information indicating features comprised in the audio signal,
input the feature information into a vector obtaining module, comprising a neural network, and obtain a feature vector corresponding to the audio signal based on the obtained feature information, and
input the feature vector into a classification module, comprising a neural network, and identify whether the audio signal is compressed two or more times,
wherein the feature information comprises information on at least one from among a feature on a frequency domain of the audio signal, a feature on a time domain of the audio signal, and a feature on a frequency-time domain of the audio signal.

2. The electronic device of claim 1, wherein
the preprocessing module comprises at least one codec preprocessing module, comprising a neural network, corresponding to at least one from among a plurality of codec types, and
at least one processor, individually and/or collectively, is configured to:
identify a codec type of the audio signal, and
input, based on the codec type of the audio signal being identified, the audio signal to a codec preprocessing module corresponding to the identified codec type from among the at least one codec preprocessing module, and obtain the feature information comprising features associated with the identified codec.

3. The electronic device of claim 2, wherein
the preprocessing module further comprises a default preprocessing module, comprising a neural network, which does not correspond to the plurality of codec types, and
at least one processor, individually and/or collectively, is configured to:
input, based on the codec type of the audio signal not being identified, the audio signal to the default preprocessing module, and obtain the feature information.

4. The electronic device of claim 3, wherein
the classification module comprises at least one codec classification module, comprising a neural network, corresponding respectively to at least one codec preprocessing module, and
at least one processor, individually and/or collectively, is configured to:
input, based on the codec type of the audio signal being identified, the feature information obtained through the at least one codec preprocessing module to the at least one codec classification module corresponding to the at least one codec preprocessing module, and identify whether the audio signal is compressed two or more times.

5. The electronic device of claim 4, wherein
the classification module further comprises a default classification module, comprising a neural network, corresponding to the default preprocessing module, and
at least one processor, individually and/or collectively, is configured to:
input, based on the codec type of the audio signal not being identified, the feature information obtained through the default preprocessing module to the default classification module, and identify whether the audio signal is compressed two or more times.

6. The electronic device of claim 5, wherein
at least one processor, individually and/or collectively, is configured to:
identify the codec type of the audio signal based on metadata of the audio signal or information on a transmission channel of the audio signal.

7. The electronic device of claim 6, wherein
the vector obtaining module corresponds to both the at least one codec preprocessing module and the default preprocessing module, and corresponds to both the at least one codec classification module and the default classification module.

8. The electronic device of claim 1, wherein
the classification module is configured to output probability information indicating whether the audio signal is compressed two or more times, and
each of the preprocessing module, the vector obtaining module, and the classification module comprises a neural network, trained according to a back-propagation of loss based on the probability information.

9. The electronic device of claim 1, further comprising:
an outputter, comprising output circuitry;
wherein at least one processor, individually and/or collectively, is configured to:
control, based on the audio signal being identified as compressed two or more times, the outputter to not output the audio signal, and output a warning message for the audio signal.

10. A method of controlling an electronic device, the method comprising:
obtaining an audio signal;
obtaining, based on inputting the audio signal into a preprocessing module, comprising a neural network, feature information indicating features comprised in the audio signal;
obtaining, based on inputting the feature information into a vector obtaining module, comprising a neural network, a feature vector corresponding to the audio signal based on the obtained feature information; and
identifying, based on inputting the feature vector into a classification module, comprising a neural network, whether the audio signal is compressed two or more times.

11. The method of claim 11, wherein
the preprocessing module comprises at least one codec preprocessing module comprising a neural network corresponding to at least one from among a plurality of codec types, and
the obtaining feature information comprises:
identifying a codec type of the audio signal; and
inputting, based on the codec type of the audio signal being identified, the audio signal into a codec preprocessing module corresponding to the identified codec type from among the at least one codec preprocessing module, and obtaining the feature information comprising features associated with the identified codec, and
the feature information comprises information on at least one from among a feature on a frequency domain of the audio signal, a feature on a time domain of the audio signal, and a feature on a frequency-time domain of the audio signal.

12. The method of claim 11, wherein
the preprocessing module further comprises a default preprocessing module, comprising a neural network, which does not correspond to the plurality of codec types, and
the obtaining feature information further comprises:
inputting, based on the codec type of the audio signal not being identified, the audio signal in the default preprocessing module, and obtaining the feature information.

13. The method of claim 12, wherein
the classification module comprises at least one codec classification module, comprising a neural network, corresponding respectively to at least one codec preprocessing module, and
the identifying whether the audio signal is compressed two or more times comprises:
inputting, based on the codec type of the audio signal being identified, the feature information obtained through the at least one codec preprocessing module into the at least one codec classification module corresponding to the at least one codec preprocessing module, and identifying whether the audio signal is compressed two or more times.

14. The method of claim 13, wherein
the classification module further comprises a default classification module, comprising a neural network, corresponding to the default preprocessing module, and
the identifying whether the audio signal is compressed two or more times further comprises:
inputting, based on the codec type of the audio signal not being identified, the feature information obtained through the default preprocessing module in the default classification module, and identifying whether the audio signal is compressed two or more times.

15. The method of claim 14, wherein
the identifying a codec type of the audio signal comprises:
identifying the codec type of the audio signal based on metadata of the audio signal or information on a transmission channel of the audio signal.
